(19) United States
(12) Patent Application Publication
(10) Pub. No.: US 2026/0251172 A1
(43) Pub. Date: Aug. 27, 2026

(54) Isolating Nut Clips

(71) Applicant: Illinois Tool Works Inc., Glenview, IL (US)

(72) Inventors: Kathryn Grace Bailey, Farmington, MI (US); Victoria Grace Brender, Gaylord, MI (US); Steven James Colarossi, Oakland Township, MI (US)

(21) Appl. No.: 19/542,307

(22) Filed: Feb. 17, 2026

Related U.S. Application Data
(60) Provisional application No. 63/762,848, filed on Feb. 25, 2025.
(60) Provisional application No. 63/767,031, filed on Mar. 5, 2025.

(51) Int. Cl. F16B 37/04; F16B 5/02; F16B 5/06

(52) U.S. Cl. CPC F16B 37/043; F16B 5/02; F16B 5/065

(57) ABSTRACT

A nut clip for coupling a first component to a second component includes a body portion formed from sheet metal, and a fastener plate supporting an internally threaded collar defining an internally threaded bore along an axis. The nut clip is configured to establish a predetermined stand-off height between the first and second components when a threaded fastener is tightened within the internally threaded bore, thereby maintaining a spacing between the first and second components. In an example, the nut clip is configured as a box nut having retention legs configured to engage an opening in the first component.

### RELATED APPLICATIONS

The present application claims priority to U.S. Provisional Patent Application Nos. 63/762,848, filed Feb. 25, 2025, and 63/767,031, filed Mar. 5, 2025, each of which are hereby incorporated by reference.

### BACKGROUND

Automotive components require fastening solutions that are straightforward to manufacture and assemble, while delivering high reliability and operational efficiency. In vehicle body and chassis applications, clips are frequently used to secure dissimilar materials, such as aluminum panels to steel structures or coated components to bare substrates. When such materials are placed in direct contact in the presence of moisture or road contaminants, galvanic corrosion may occur, leading to premature degradation, reduced structural integrity, and increased warranty costs. Accordingly, there is a need for fastening solutions that not only secure components but also provide electrical and/or physical isolation between adjacent parts to mitigate the effects of galvanic corrosion.

Clips are widely used across numerous industries to secure, fasten, or retain components. Conventional clip designs typically rely on elastic deformation to generate clamping force. However, excessive compression during installation or in-service loading may result in material fatigue, permanent deformation, or failure of the clip and/or the retained components. In automotive panel assemblies and other structural interfaces, over-compression can crush coatings, deform lightweight materials, or compromise sealing features. In sensitive applications—such as electronics, medical devices, precision assemblies, and vehicle body panels—it is particularly important to control the maximum compressive force applied in order to prevent damage and ensure proper function.

Accordingly, notwithstanding existing developments, there remains a need for an improved clip that provides secure retention while isolating adjacent components to reduce or eliminate galvanic corrosion, and, in some cases, incorporates features that limit maximum compression to prevent crushing or deformation of one or more retained components. Such a clip would enhance durability, protect surface treatments and lightweight materials, safeguard delicate components, and promote consistent performance over repeated installation and removal cycles.

### SUMMARY

The present disclosure relates generally to a nut clip forming a connection between two components, such as vehicular components, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates a topside isometric assembly view of a fastening system with a fastener assembly having a nut clip in accordance with a first aspect of this disclosure.

FIG. 1b illustrates a topside isometric assembled view of the fastening system.

FIG. 1c illustrates a cross-sectional side elevation view of the fastening system taken along cutline A-A (FIG. 1b).

FIG. 2a illustrates a topside isometric view of the nut clip for FIGS. 1a through 1c.

FIG. 2b illustrates an underside isometric view of the nut clip.

FIG. 2c illustrates a top plan view of the nut clip.

FIG. 2d illustrates a bottom plan view of the nut clip.

FIG. 2e illustrates an elevation view of a first side of the nut clip.

FIG. 2f illustrates an elevation view of a second side of the nut clip.

FIG. 2g illustrates an elevation view of a third side of the nut clip.

FIG. 2h illustrates an elevation view of a fourth side of the nut clip.

FIG. 3a illustrates a topside isometric assembly view of a fastening system with a fastener assembly having a nut clip in accordance with a second aspect of this disclosure.

FIG. 3b illustrates a topside isometric assembled view of the fastening system.

FIG. 3c illustrates a cross-sectional side elevation view of the fastening system taken along cutline B-B (FIG. 4a).

FIG. 4a illustrates a topside isometric view of the nut clip for FIGS. 3a through 3c.

FIG. 4b illustrates an underside isometric view of the nut clip.

FIG. 4c illustrates a top plan view of the nut clip.

FIG. 4d illustrates a bottom plan view of the nut clip.

FIG. 4e illustrates an elevation view of a first side of the nut clip.

FIG. 4f illustrates an elevation view of a second side of the nut clip.

FIG. 4g illustrates an elevation view of a third side of the nut clip.

FIG. 4h illustrates an elevation view of a fourth side of the nut clip.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered. It will be understood that directional references (e.g., upper, lower, upwardly, downwardly) are used for convenience with respect to the orientation shown in the figures and are not intended to limit the scope of the disclosure.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. Terms such as “can,” “may,” and “in certain embodiments” are used to reflect that variations are contemplated. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a nut clip to form a connection between two components, such as vehicular components.

In one example, a nut clip configured to couple a first component to a second component comprises: a body portion formed from sheet metal; a fastener plate forming a first portion of the body portion; an internally threaded collar supported by the fastener plate and defining an internally threaded bore along an axis; at least one planar portion spaced from the fastener plate by at least one spring bend; and an annular spacer formed in the planar portion and aligned with the internally threaded collar along the axis, wherein the annular spacer is configured to establish a predetermined stand-off height between the first component and the second component when a fastener is tightened within the internally threaded bore.

In some examples, the annular spacer comprises a hollow cylindrical wall defining a fastener opening aligned with the internally threaded bore.

In some examples, the annular spacer and the internally threaded collar extend in a same axial direction from the body portion.

In some examples, the planar portion is offset relative to the fastener plate by the spring bend to define a predetermined axial gap height.

In some examples, the nut clip of claim 1, further comprising a pair of legs extending from the fastener plate and configured to engage an opening in the first component.

In some examples, at least one of the legs includes a retention feature configured to engage a perimeter of the opening in the first component.

In some examples, the internally threaded collar is formed by extrusion from the fastener plate.

In some examples, the body portion is formed from a single piece of sheet metal.

In some examples, the annular spacer is configured to be at least partially received within the opening of the second component to provide radial alignment of the fastener.

In one example, a fastening assembly comprises: at least one of the above-described nut clips; and a threaded fastener configured to extend through an opening in the second component and threadedly engage the internally threaded collar, wherein tightening of the fastener causes compressive load to be transferred through the annular spacer to limit compression between the first component and the second component.

In one example, a nut clip configured to couple a first component to a second component comprises: a body portion formed from sheet metal and defining a U-shaped channel dimensioned to receive an edge portion of the first component; a first planar portion and a second planar portion connected by at least one spring bend to permit resilient clamping engagement with the first component; a fastener plate supporting an internally threaded collar defining an internally threaded bore along an axis; and an annular spacer integrally formed in the first planar portion and aligned with the internally threaded collar along the axis, wherein the annular spacer is configured to establish a predetermined stand-off height between the first component and the second component when a fastener is tightened within the internally threaded bore.

In some examples, the annular spacer comprises a hollow cylindrical wall defining a fastener opening aligned with the internally threaded bore.

In some examples, the internally threaded collar is extruded from the fastener plate.

In some examples, the first planar portion includes an engineered offset relative to the fastener plate to define a predetermined axial gap height.

In some examples, the nut clip further comprises a guide lip configured to facilitate sliding engagement of the U-shaped channel onto the edge portion of the first component.

In some examples, the nut clip further comprises a component-engagement feature configured to project into an opening of the first component to provide axial retention.

In some examples, the annular spacer and the internally threaded collar extend in a same axial direction from the body portion.

In some examples, the body portion is formed from a single piece of sheet metal.

In one example, a fastening assembly comprises: at least one of the above-described nut clips; and a threaded fastener configured to extend through an opening in the second component and threadedly engage the internally threaded collar, wherein tightening transfers compressive load through the annular spacer to limit compression between the first component and the second component.

In some examples, the annular spacer is at least partially received within the opening in the second component to provide radial alignment of the fastener relative to the nut clip.

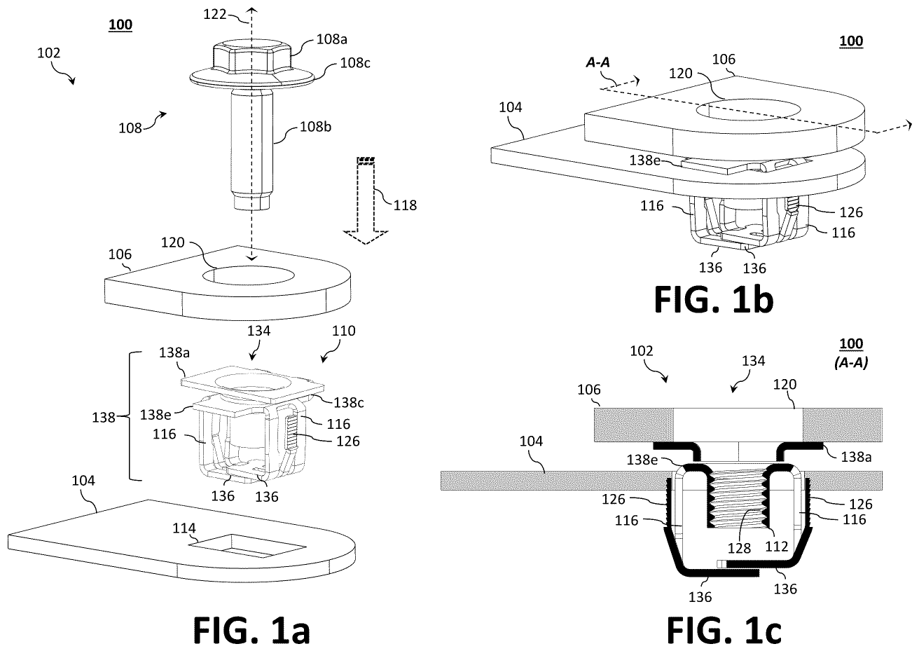

FIG. 1a illustrates a topside isometric assembly view of a fastening system 100 with a fastener assembly 102 having a nut clip 110 in accordance with a first aspect of this disclosure. FIG. 1b illustrates a topside isometric assembled view of the fastening system 100, while FIG. 1c illustrates a cross-sectional side elevation view of the fastening system 100 taken along cutline A-A (FIG. 1b).

The fastening system 100 can include a fastener assembly 102 configured to couple a first component 104 to a second component 106. The fastening system 100 may be suitable for automotive applications, although it will be appreciated that the fastening system 100 can be used in other industries and environments where controlled clamping, component isolation, compression limiting, and secure retention are desirable.

In this example, the nut clip 110 is configured as a box nut including an engineered offset formed in a top plane of the body portion 138. The offset may be created by bending back at least a portion of the first planar portion 138a relative to the fastener plate 138e to establish a predetermined gap height. The first planar portion 138a and the fastener plate 138e may be arranged substantially parallel to one another and spaced apart by a defined axial distance, which may correspond to a desired stand-off or isolation height when installed between components. The first planar portion 138a and the fastener plate 138e can be connected via a spring bend 138c.

This configuration can maintain the general structural and functional characteristics of a flush-fit box nut—including the internally threaded collar 112 supported by the fastener plate 138e and retention features configured to engage an opening 114 of a first component 104—while introducing a deliberate vertical separation relative to the second component 106. The engineered metal offset may provide a solid and durable stand-off structure that resists collapse under clamp load and maintains dimensional stability over time. As a result, the nut clip 110 can provide controlled spacing, improved galvanic isolation between dissimilar materials, and consistent compression management.

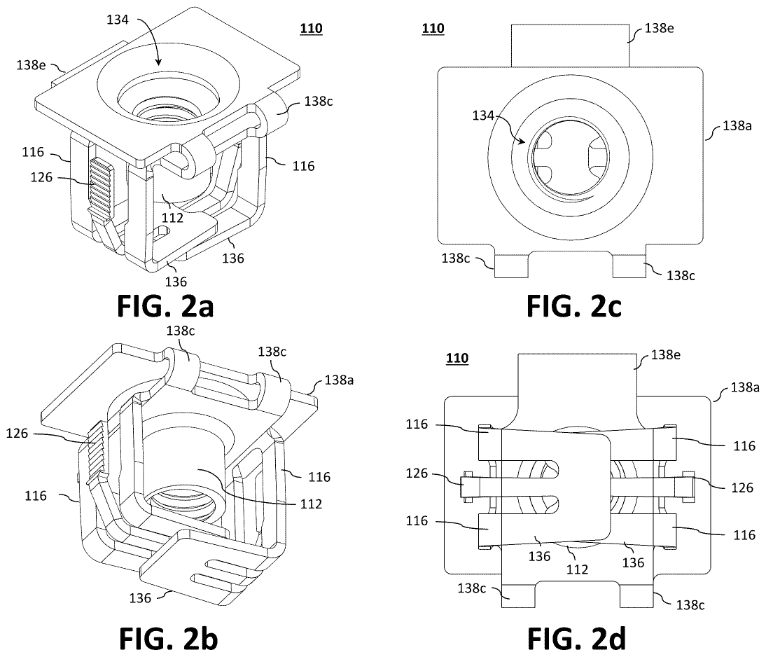

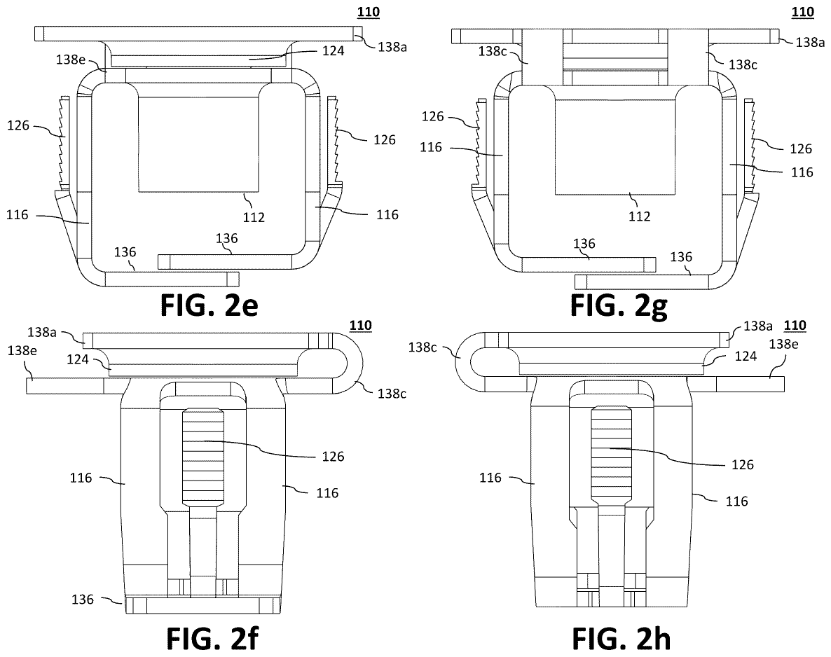

The fastener assembly 102 can include a fastener 108 and a nut clip 110. FIG. 2a illustrates a topside isometric view of the nut clip 110 for FIGS. 1a through 1c, while FIG. 2b illustrates an underside isometric view of the nut clip 110. FIGS. 2c and 2d illustrate, respectively, top and bottom plan views of the nut clip 110. FIGS. 2e through 2h illustrate, respectively, elevation views of a first, second, third, and fourth sides of the nut clip 110. The nut clip 110 may include an internally threaded collar 112 configured to threadedly receive the fastener 108 along an axis of rotation 122.

An annular spacer 124 may be formed in the first planar portion 138a between the first planar portion 138a and the fastener plate 138e. The annular spacer 124 functions as a spacing feature configured to maintain a defined gap between the planar portion 138a and the fastener plate 138e under compressive load. These spacing features may contribute to structural rigidity, load distribution, and consistent compression-limiting performance.

The nut clip 110 can further be configured to provide mechanical retention to the first component 104 prior to full assembly and to provide electrical and/or physical isolation between adjacent components.

The first component 104 and the second component 106 may be fabricated from similar or dissimilar materials. For example, in automotive applications, the first component 104 may comprise a steel structural member and the second component 106 may comprise an aluminum panel, coated substrate, composite structure, or polymeric trim component. When dissimilar metals are placed in contact in the presence of moisture or road contaminants, galvanic corrosion may occur. The nut clip 110 may maintain controlled spacing between the first component 104 and the second component 106 when installed, thereby reducing direct metal-to-metal contact and mitigating galvanic corrosion.

To facilitate installation of the fastener assembly 102, the first component 104 can include a first opening 114, and the second component 106 can include a second opening 120. In the illustrated embodiment, the first opening 114 may be generally quadrilateral, such as square or rectangular, and may be dimensioned to receive at least a portion of the nut clip 110 in a snap-fit or interference-fit manner. The second opening 120 may be generally circular and may be dimensioned to receive the shank 108b of the fastener 108.

The first opening 114 and the second opening 120 may be formed during manufacture of the respective components (e.g., stamping, punching, molding, casting) or may be formed in a secondary operation (e.g., drilling, laser cutting, machining). Optional chamfers, radiused edges, or lead-in features may be included to facilitate insertion, centering, and alignment of the nut clip 110 and/or fastener 108.

When assembled, the second component 106 can be positioned relative to the first component 104 such that the second opening 120 is aligned with the first opening 114 and the internally threaded collar 112 of the nut clip 110.

The nut clip 110 can include a body portion 138, which in certain embodiments may be formed from a single piece of material, such as sheet metal. The body portion 138 may include one or more planar portions (e.g., planar portion 138a) connected to a fastener plate 138e by one or more integral spring bends 138c, such as U-shaped bends. The spring bends 138c can impart resilient characteristics to the nut clip 110 and may enable the nut clip 110 to elastically deform during insertion into the first opening 114 and return toward a predetermined unstressed configuration to provide retention.

In the illustrated embodiment, the nut clip 110 may be configured as a box nut. A fastener plate 138e can form a lower portion of the nut clip 110 and may support or define the internally threaded collar 112. A pair of legs 116 may extend generally perpendicular from the fastener plate 138e. The distal ends 136 of the legs 116 can be bent inwardly and may be generally parallel to the fastener plate 138e, thereby forming a box-like structure. In certain embodiments, the distal ends 136 may overlap one another. One or more attachment features, such as tabs 126, may be provided on the legs 116 to engage edges of the first opening 114 and provide retention. These retention features can be configured to resist push-through of the nut clip 110 relative to the first component 104 and to provide tactile and/or audible feedback when fully seated.

The nut clip 110 may be configured for insertion into a conventional square or rectangular aperture in the first component 104. Upon insertion, the legs 116 can elastically deflect and then engage the perimeter of the first opening 114.

The fastener plate 138e may comprise or define the internally threaded collar 112. The internally threaded collar 112 can include a cylindrical body defining an internally threaded bore 128. The bore 128 may be configured to threadedly engage the externally threaded shank 108b of the fastener 108. In certain embodiments, the cylindrical body may be formed by extrusion of material from the fastener plate 138e and subsequently tapped or thread-formed to define internal threads. The internally threaded collar 112 can be rotationally fixed relative to the body portion 138 such that rotation of the fastener 108 about axis 122 advances the fastener axially without causing substantial rotation of the nut clip 110 during tightening.

The planar portion 138a can include an integrally formed annular spacer 124. In the illustrated embodiment, the annular spacer 124 may comprise a short, hollow cylindrical wall defining a fastener opening 134. The fastener opening 134 can be aligned with and generally concentric to the internally threaded bore 128 of the collar 112 along axis 122. The fastener opening 134 can be sized to slidingly receive the shank 108b of the fastener 108.

The annular spacer 124 and the internally threaded collar 112 may extend in the same axial direction from a common region of the body portion 138. For example, the annular spacer 124 can extend downwardly relative to the planar portion 138a toward the fastener plate 138e, while the internally threaded collar 112 may extend downwardly from the fastener plate 138e away from the second component 106. In certain embodiments, the planar portion 138a and the fastener plate 138e may be arranged substantially parallel to one another and spaced apart by a predetermined distance, which may be selected to contribute to the desired overall stand-off height or distance between the first and second components 104, 106.

During tightening of the fastener 108, compressive load can be transferred from the head 108a and flange 108c of the fastener 108 to the second component 106 and then through the annular spacer 124 to the first component 104. Once the annular spacer 124 is engaged between the first component 104 and the second component 106, further tightening of the fastener 108 may result primarily in load transfer through the annular spacer 124. This configuration may mitigate direct contact between the first and second components 104, 106.

The fastener 108 can include a head 108a, a shank 108b, and a flange 108c. In the illustrated embodiment, the head 108a may be hexagonal to facilitate engagement by a socket, wrench, or similar tool. The shank 108b may include external threads configured to mate with the internally threaded bore 128 of the collar 112. The flange 108c can increase the contact surface area between the head 108a and the second component 106, distributing clamping load and reducing localized stresses. Although a hex-head bolt is illustrated, other fastener configurations may be used, including alternative head geometries or drive types, provided that the fastener is compatible with the internally threaded collar 112.

During installation, the nut clip 110 can be inserted into the first opening 114 of the first component 104 in the direction indicated by arrow 118. The legs 116 may deflect as necessary to pass through the opening and then engage the perimeter of the opening to retain the nut clip 110 in position. The second component 106 can then be positioned over the first component 104 such that the annular spacer 124 aligns with the second opening 120. The fastener 108 can be inserted through the second opening 120, through the fastener opening 134 of the annular spacer 124, and into threaded engagement with the internally threaded collar 112. Rotation of the fastener 108 about axis 122 can advance the fastener axially and draw the first and second components 104, 106 together, while the annular spacer 124 serves to maintain a predetermined minimum distance between the planar portion 138a and the fastener plate 138e.

Optional sealing elements may be provided to mitigate ingress of dust, dirt, water, or other environmental contaminants. For example, a compressible annular seal may be positioned radially about the shank 108b and axially between the second component 106 and the underside of the head 108a to provide a fluid-resistant barrier.

The nut clip 110 may be fabricated from sheet metal using stamping, punching, coining, bending, and extrusion operations. In certain embodiments, the nut clip 110 can be formed from a single sheet of metal that is progressively stamped and bent to create the body portion 138, the annular spacer 124, the internally threaded collar 112, the legs 116, the tabs 126, and associated features. The annular spacer 124 and the internally threaded collar 112 may be integrally formed from the material of the body portion 138.

The fastener 108 may be fabricated from metal using cold forming, forging, or machining techniques. In alternative embodiments, certain components may be fabricated from polymeric materials using injection molding or additive manufacturing processes, including fused deposition modeling (FDM), stereolithography (SLA), selective laser sintering (SLS), material jetting, binder jetting, powder bed fusion, directed energy deposition, vat photopolymerization, or similar processes.

The first component 104 and the second component 106 may comprise automotive panels, trim components, structural members, pillars, dashboard components, seat frames, center consoles, fenders, sheet metal framework, or other substrates. These components may be fabricated from metals or metal alloys, synthetic or semi-synthetic polymers (including acrylonitrile butadiene styrene (ABS) and polyvinyl chloride (PVC)), composite materials (including fiberglass), or combinations thereof.

In view of the foregoing, the nut clip 110 can provide secure retention within a component opening, controlled compression through the annular spacer 124, a defined axial stand-off, load transfer through a compression-limiting structure, and isolation between adjacent components to mitigate galvanic corrosion. By separating retention and compression-limiting functions and integrating an engineered compression limiter into a nut clip compatible with standard apertures, the nut clip 110 can enhance installation reliability, protect component integrity, and promote consistent performance over repeated installation and service cycles.

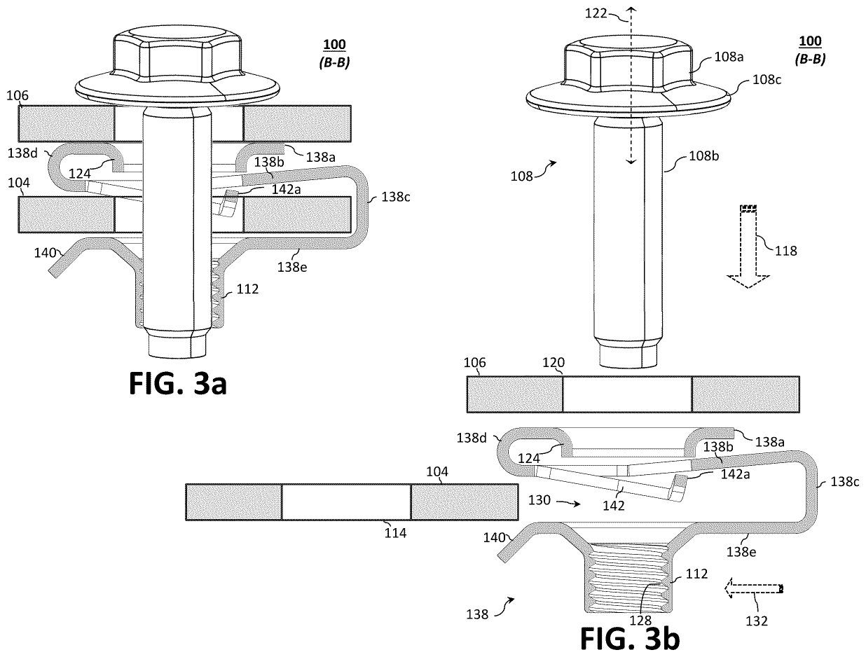

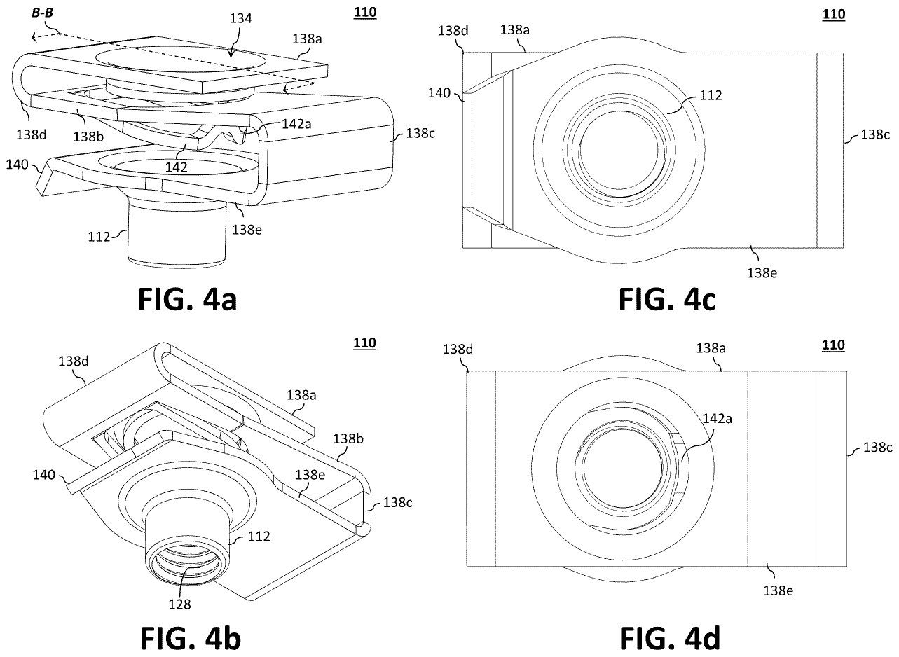

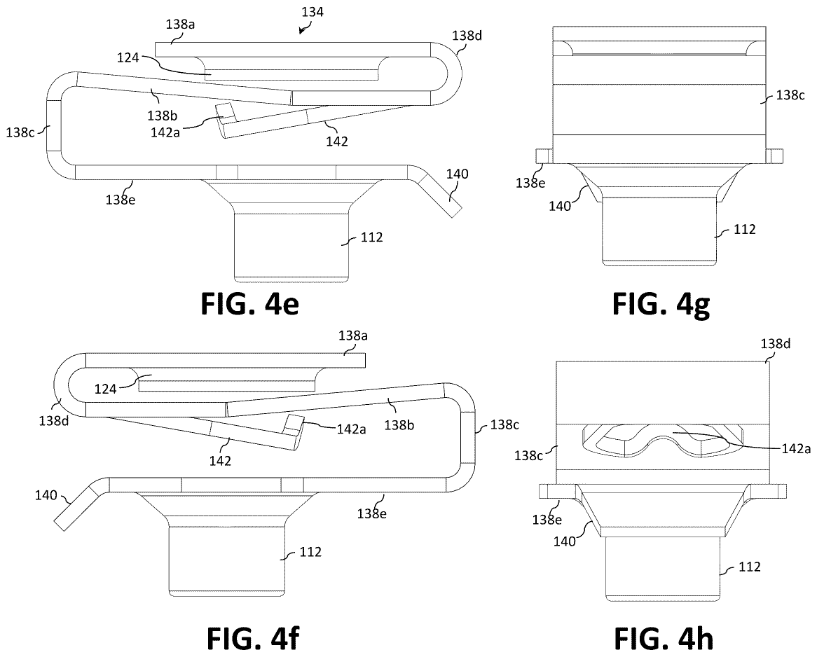

FIGS. 3a through 3c illustrate another example of the fastening system 100 in which the nut clip 110 is configured as a U-nut rather than a box nut. Unless otherwise specified, like reference numerals refer to like elements described in connection with FIGS. 1a-1c and 2a-2h, and similar structural features may function in a similar manner. More particularly, FIG. 3a illustrates a topside isometric assembly view of a fastening system 100 with a fastener assembly 102 having a nut clip 110 in accordance with a first aspect of this disclosure. FIG. 3b illustrates a top-side isometric assembled view of the fastening system 100, while FIG. 3c illustrates a cross-sectional side elevation view of the fastening system 100 taken along cutline A-A (FIG. 4a).

In this example, the nut clip 110 includes a body portion 138 defining a generally U-shaped channel 130 dimensioned to receive an edge portion of the first component 104. The body portion 138 may include a first planar portion 138a and a second planar portion 138b resiliently connected by an integral spring bend 138d. The second planar portion 138b may be resiliently connected to the fastener plate 138e by an integral spring bend 138c. The second planar portion 138b and the fastener plate 138e may be biased toward one another such that insertion of the edge of the first component 104 into the channel 130 causes elastic deflection and subsequent clamping retention.

An engineered offset may be formed in the first planar portion 138a in a manner similar to the box nut example. The first planar portion 138a may be arranged substantially parallel to the fastener plate 138e and spaced apart by a predetermined distance to define a stand-off height. The first planar portion 138a may also be arranged substantially parallel to a portion of the second planar portion 138b when assembled. An annular spacer 124 may be integrally formed in the first planar portion 138a and aligned with the internally threaded collar 112 along axis 122.

FIG. 4a illustrates a topside isometric view of the nut clip 110 for FIGS. 3a through 3c, while FIG. 4b illustrates an underside isometric view of the nut clip 110. FIGS. 4c and 4d illustrate, respectively, top and bottom plan views of the nut clip 110. FIGS. 4e through 4h illustrate, respectively, elevation views of a first, second, third, and fourth sides of the nut clip 110. The nut clip 110 may include an internally threaded collar 112 configured to threadedly receive the fastener 108 along an axis of rotation 122.

The internally threaded collar 112 may be formed by extrusion from a plate portion of the body portion 138 (e.g., the fastener plate 138e) and may define the internally threaded bore 128 configured to receive the fastener 108. The collar 112 may be rotationally fixed relative to the body portion 138.

During installation, the nut clip 110 may be advanced onto an edge of the first component 104, as indicated by arrow 132, such that the edge of the first component 104 is received within the channel 130 between the fastener plate 138e and the second planar portion 138b. A guide lip 140, which may be sloped and formed at the entrance to the channel 130, may facilitate sliding engagement and reduce misalignment during installation. In the illustrated example, the guide lip 140 is formed on the fastener plate 138e, but other locations are contemplated, such as the second planar portion 138b.

A component-engagement feature 142 may be formed in or on the body portion 138 and may project into the first opening 114 of the first component 104 to provide tactile and/or audible feedback and axial retention. For example, the second planar portion 138b can define the component-engagement feature 142. The component-engagement feature 142 can include or define a clip feature 142a shaped to provide tactile feedback when engaging the opening 114 in the first component 104 (e.g., a click or similar feedback). The nut clip 110 may therefore be preinstalled onto the first component 104 as a part-in-assembly prior to introduction of the second component 106.

Once the nut clip 110 is secured to the edge of the first component 104, the second component 106 may be positioned such that the annular spacer 124 aligns with the second opening 120. The fastener 108 may be inserted through the second opening 120 and into threaded engagement with the internally threaded collar 112. Tightening of the fastener 108 may transfer compressive load through the annular spacer 124, establishing a controlled stand-off between the first and second components 104, 106.

As in the box nut example, the annular spacer 124 and the spaced planar portion 138a relative to the fastener-supporting portion of the body portion 138 contribute to compression limiting and may reduce sustained metal-to-metal contact between dissimilar materials, thereby mitigating galvanic corrosion while maintaining consistent clamp load over repeated installation cycles.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed:

1. A nut clip configured to couple a first component to a second component, comprising:
a body portion formed from sheet metal;
a fastener plate forming a first portion of the body portion;
an internally threaded collar supported by the fastener plate and defining an internally threaded bore along an axis;
at least one planar portion spaced from the fastener plate by at least one spring bend; and
an annular spacer formed in the planar portion and aligned with the internally threaded collar along the axis,
wherein the annular spacer is configured to establish a predetermined stand-off height between the first component and the second component when a fastener is tightened within the internally threaded bore.

2. The nut clip of claim 1, wherein the annular spacer comprises a hollow cylindrical wall defining a fastener opening aligned with the internally threaded bore.

3. The nut clip of claim 1, wherein the annular spacer and the internally threaded collar extend in a same axial direction from the body portion.

4. The nut clip of claim 1, wherein the planar portion is offset relative to the fastener plate by the spring bend to define a predetermined axial gap height.

5. The nut clip of claim 1, further comprising a pair of legs extending from the fastener plate and configured to engage an opening in the first component.

6. The nut clip of claim 5, wherein at least one of the legs includes a retention feature configured to engage a perimeter of the opening in the first component.

7. The nut clip of claim 1, wherein the internally threaded collar is formed by extrusion from the fastener plate.

8. The nut clip of claim 1, wherein the body portion is formed from a single piece of sheet metal.

9. The nut clip of claim 1, wherein the annular spacer is configured to be at least partially received within an opening of the second component to provide radial alignment of the fastener.

10. A fastening assembly comprising:
the nut clip of claim 1; and
a threaded fastener configured to extend through an opening in the second component and threadedly engage the internally threaded collar,
wherein tightening of the fastener causes compressive load to be transferred through the annular spacer to limit compression between the first component and the second component.

11. A nut clip configured to couple a first component to a second component, comprising:
a body portion formed from sheet metal and defining a U-shaped channel dimensioned to receive an edge portion of the first component;
a first planar portion and a second planar portion connected by at least one spring bend to permit resilient clamping engagement with the first component;
a fastener plate supporting an internally threaded collar defining an internally threaded bore along an axis; and
an annular spacer integrally formed in the first planar portion and aligned with the internally threaded collar along the axis,
wherein the annular spacer is configured to establish a predetermined stand-off height between the first component and the second component when a fastener is tightened within the internally threaded bore.

12. The nut clip of claim 11, wherein the annular spacer comprises a hollow cylindrical wall defining a fastener opening aligned with the internally threaded bore.

13. The nut clip of claim 11, wherein the internally threaded collar is extruded from the fastener plate.

14. The nut clip of claim 11, wherein the first planar portion includes an engineered offset relative to the fastener plate to define a predetermined axial gap height.

15. The nut clip of claim 11, further comprising a guide lip configured to facilitate sliding engagement of the U-shaped channel onto the edge portion of the first component.

16. The nut clip of claim 11, further comprising a component-engagement feature configured to project into an opening of the first component to provide axial retention.

17. The nut clip of claim 11, wherein the annular spacer and the internally threaded collar extend in a same axial direction from the body portion.

18. The nut clip of claim 11, wherein the body portion is formed from a single piece of sheet metal.

19. A fastening assembly comprising:
the nut clip of claim 11; and
a threaded fastener configured to extend through an opening in the second component and threadedly engage the internally threaded collar,
wherein tightening of the fastener transfers compressive load through the annular spacer to limit compression between the first component and the second component.

20. The fastening assembly of claim 19, wherein the annular spacer is at least partially received within the opening in the second component to provide radial alignment of the fastener relative to the nut clip.
